(19) United States
(12) Patent Application Publication
(10) Pub. No.: US 2025/0322813 A1
(43) Pub. Date: Oct. 16, 2025

(54) APPARATUS AND METHOD OF USE THEREOF FOR SUPPORT OF VIOLIN OR VIOLA WHILE PLAYING

(71) Applicant: Alexei Chipovalov, San Jose, CA (US)

(72) Inventor: Alexei Chipovalov, San Jose, CA (US)

(21) Appl. No.: 18/741,532

(22) Filed: Jun. 12, 2024

Related U.S. Application Data
(60) Provisional application No. 63/634,891, filed on Apr. 16, 2024.

(51) Int. Cl. G10D 3/18

(52) U.S. Cl. CPC G10D 3/18

(57) ABSTRACT

Apparatus and methods for support of a violin or viola instrument while the instrument is being played are disclosed. A rod has a changeable shape and is configured for resting on a player's shoulder. The rod is sufficiently malleable that its shape is changeable by hand for adjustment and the rod is sufficiently rigid that it maintains it shape during playing of the instrument. An attachment mechanism is configured to attach the rod to a violin or viola. A counterweight is attached to the rod at a distance from the attachment mechanism, wherein adjustment of the rod and adjustment of counterweight are capable of achieving a center of gravity of the instrument and apparatus being in or around an area where apparatus rests on the player's shoulder.

This application claims priority of U.S. Provisional Application No. 63/634,891, filed Apr. 16, 2024, the entire contents of which are hereby incorporated by reference.

### BACKGROUND OF THE INVENTION

The present invention relates to the field of musical instruments and, more particularly, the present invention relates to apparatus and methods for support of a violin or viola while the instrument is being played.

The standard manner of holding a violin or viola while playing the instrument is with the left side of the player's jaw resting on a chinrest of the instrument and with the instrument being supported by the player's left shoulder. The instrument can be equipped with a shoulder rest. The instrument must be held firmly between the jaw and the shoulder so that it remains stable while the player's left hand works the fingerboard and the player's right hand draws the bow across the strings. There can be some variation in the manner in which individuals hold such instruments, possibly due to different individual characteristics, such as the shape of the player's shoulders, length of the player's neck, etc. Such variation in the particular manner in which the instrument is held can also result from different traditions or “schools.”

The above-described manner of holding a violin or viola can result in adverse health impacts which can include discomfort, especially when playing for long periods as is required for a player to become proficient. Violin and viola players can also experience pain in the areas of the shoulder, neck and upper back even when not actively playing which may result from, or be worsened by, prolonged periods of playing.

There have been a number of inventions intended to ease holding a violin or viola while playing. Examples are as follows:

U.S. Patent Publication No. 2021/01587788 discloses a harness for a violin or viola with an adjustable neck strap that clips onto a lightweight harness.

U.S. Pat. No. 11,081,094 discloses “a support mechanism comprising: a rigid loop, fitted with a hinge and clasp, that is worn around a neck of a musician, permitting the wearable support to be worn by the musician playing the instrument.”

U.S. Pat. No. 2,576,018 discloses an “appropriately shaped reach arm or member fastened at one end to the intermediate portion of the truss and having a collar at its opposite end to embrace the neck of the user.”

U.S. Patent Publication No. 2005/0183564 discloses “a violin support which fits around the neck of a musician.”

U.S. Pat. No. 9,978,351 discloses a modular apparatus “worn over at least one shoulder and around the back of the user's neck.”

U.S. Pat. No. 4,913,027 discloses a “body harness means for engaging one shoulder and at least the torso of the musician without applying pressure to the neck.”

U.S. Pat. No. 7,544,871 discloses a “flexible material slipped under the tailpiece of the instrument, over the adjacent shoulder of the musician, down diagonally across the musician's back, under the opposite underarm, and upwardly across the musician's chest.”

U.S. Pat. No. 413,807 discloses as “arm which is supported at its lower end on a buckle-plate held on the body The upper end of the supporting-arm is provided with clamping-disks, which are applied to the body of the violin”

U.S. Pat. No. 10,089,970 discloses a “telescoping chest pad is secured to one end of the concave plate for supporting the instrument using the body.”

U.S. Pat. No. 7,368,645 discloses a “collar-bone rest and a chest rest, providing a dual plane design.”

U.S. Patent Publication No. 2016/0300553 discloses a “harness [that] supports the weight of a violin or a viola, eliminating the need for the player to engage the neck or chin to support the instrument while playing” and that “[s]uch an ergonomic apparatus may be further equipped with a counterweight.”

U.S. Pat. No. 10,885,889 discloses a “curved, flexible balancing section comprises a series of pockets into which weights can be placed.”

What is needed is an improved technique for support of a violin or viola while the instrument is being played.

### SUMMARY OF THE INVENTION

Apparatus and methods for support of a violin or viola instrument while the instrument is being played are disclosed. In accordance with an embodiment, a rod has a changeable shape and is configured for resting on a player's shoulder. The rod is sufficiently malleable that its shape is changeable by hand for adjustment and the rod is sufficiently rigid that it maintains it shape during playing of the instrument. An attachment mechanism is configured to attach the rod to a violin or viola. A counterweight is attached to the rod at a distance from the attachment mechanism, wherein adjustment of the rod and adjustment of the counterweight are capable of achieving a center of gravity of the instrument and apparatus being in or around an area where apparatus rests on the player's shoulder.

In accordance with a further embodiment, a rod has a changeable shape and is configured for resting on a player's shoulder. The rod is sufficiently malleable that its shape is changeable by hand for adjustment and the rod is sufficiently rigid that it maintains it shape during playing of the instrument. An attachment mechanism is configured to attach the rod to a violin or viola. In this embodiment, an elastic element is attached to the rod at a distance from the attachment mechanism and is configured to be attached to the player, wherein adjustment of the rod and adjustment of elastic element are capable of achieving a center of gravity of the instrument and apparatus being in or around an area where apparatus rests on the player's shoulder.

In accordance with another embodiment, a method of supporting a violin or viola instrument in a playing position is provided. The method comprises configuring a rod having a changeable shape such that the rod rests on a player's shoulder. The rod is sufficiently malleable that its shape is changeable by hand for adjustment and the rod is sufficiently rigid that it maintains it shape during playing of the instrument. The method further comprises attaching a first end of the rod to the instrument and attaching a counterweight to the rod at a distance from the first end. The method additionally comprises adjusting one or more of the distance, mass of the counterweight, and the changeable shape of the rod such that a center of gravity of the instrument and attached rod and counterweight is in or around an area where the rod or instrument rests on the player's shoulder.

These and other embodiments are fully disclosed herein.

### BRIEF DESCRIPTION OF THE DRAWINGS

The present invention is described with respect to particular exemplary embodiments thereof and reference is accordingly made to the drawings in which:

FIG. 1 illustrates an apparatus for support of violin or viola in accordance with an embodiment of the present invention;

FIG. 2 illustrates an apparatus for support of violin or viola attached to a violin or viola in accordance with an embodiment of the present invention;

FIG. 3 illustrates a front view of a person using an apparatus for support of violin or viola in accordance with an embodiment of the present invention;

FIG. 4 illustrates a rear view of a person using an apparatus for support of violin or viola in accordance with an embodiment of the present invention; and

FIG. 5 illustrates a rear view of a person using an apparatus for support of violin or viola in accordance with an alternative embodiment of the present invention.

### DETAILED DESCRIPTION OF A PREFERRED EMBODIMENT OF THE INVENTION

The present invention comprises apparatus and methods for support of a violin or viola while the instrument is being played. The apparatus comprises a rod that is configured for attachment to the instrument. This can be accomplished by an attachment mechanism, such as instrument clamps and a supporting member, which is attached to the rod at one end. At a distance from the instrument and along the rod, a counterweight is attached. In use, the apparatus rests on the player's shoulder and supports the instrument in a suitable playing position comfortably and with minimal effort. The rod is sufficiently malleable that it can be bendable for adjustment to optimize fitment to individual players and instruments. The rod is also sufficiently rigid that it maintains it shape during use. Similarly, the counterweight can be adjustable to optimize fitment to individual players and instruments, for example, by adding or removing mass or repositioning the counterweight along the rod. The counterweight preferably maintains its weight and position along the rod during use.

The invention is useful for: (1) beginners and students for learning correct posture and instrument positioning; (2) students and professional musicians to enable prolonged periods practice while reducing fatigue; (3) musicians who may suffer from adverse health effects or injury resulting from past use of such instruments; and (4) elder players, children and persons with health issues who may lack strength and/or coordination and/or who may suffer from other issues that interfere with their ability to support a violin or viola while playing the instrument.

If desired, the balancing force can be gradually reduced to aid in learning of how to hold the instrument in proper position. This can be accomplished, for example, by gradually reducing the counterweight or making other adjustments over time. Eventually, this could allow the player to learn how to hold the instrument in proper position without use of the support apparatus of the present invention.

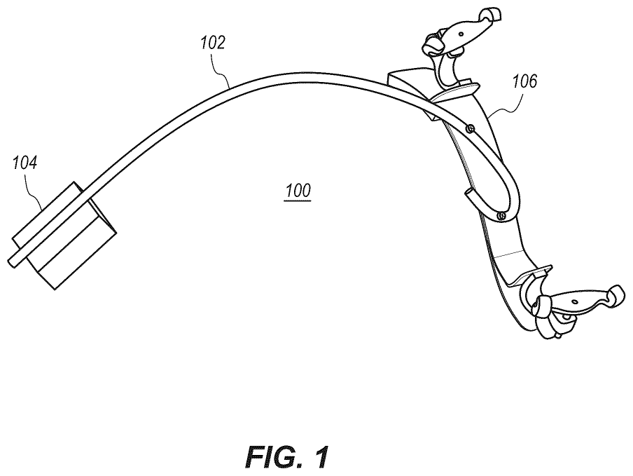

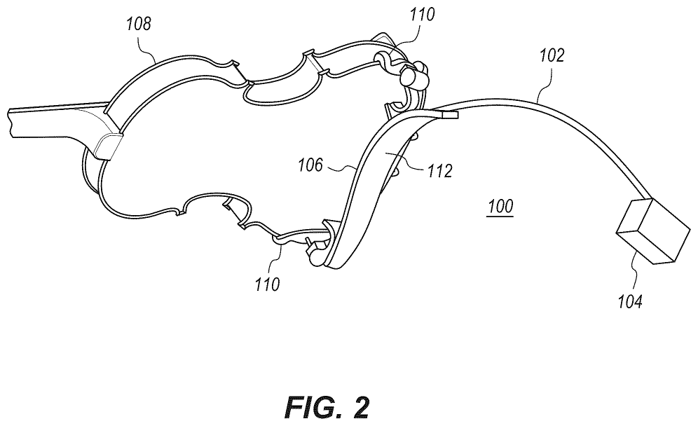

FIG. 1 illustrates an apparatus 100 for support of violin or viola in accordance with an embodiment of the present invention. As shown in FIG. 1, the apparatus 100 comprises a rod 102, a counterweight 104 and an attachment mechanism 106. FIG. 2 illustrates the apparatus 100 attached to an instrument 108, which can be a violin, viola or similar instrument, in accordance with an embodiment of the present invention.

Referring to FIGS. 1 and 2, at or near one end of the rod 102, the counterweight 104 is attached. At an opposite end of the rod 102 is the attachment mechanism 106 which provides for attachment of the rod 102 to the instrument 108. Together, the rod 102, counterweight 104 and attachment mechanism 106 hold the instrument 108 in a proper playing position by a force created by the rod 102 and counterweight 104 as well as support of the player's shoulder. To accomplish this, the rod 102 can preferably be bent, adjusted, curved, shaped, and/or formed in such a way as to achieve a suitable and comfortable playing position for the instrument.

The attachment mechanism 106 is configured to attach the rod 102 to the instrument 108. For this purpose, the attachment mechanism 106 can, for example, comprise clamps 110 for attachment to the instrument. Clamps are preferred as they are capable of removably attaching the mechanism 106 to the instrument 108 without damaging the instrument. It will be apparent that other releasable mechanical fasteners could be used, such as bands or double-sided tape. The rod 102 can be attached to the attachment mechanism 106 permanently or via clamps or other releasable fasteners.

Additionally, the attachment mechanism 106 can comprise a shoulder rest 112. The shoulder rest 112 can be curved so as to fit over the player's shoulder adjacent to the instrument 108. In embodiments that include a shoulder rest 112, the rod 102 can be attached to the shoulder rest 112 permanently or via clamps or other releasable fasteners. The shoulder rest 112 is preferably configured and positioned such that the center of gravity of the assembly consisting of the support apparatus 100 (including the rod 102, counterweight 104 and attachment mechanism 106) and the instrument 108 is positioned on or around the area where the support assembly 100, and particularly the shoulder rest 112, rests on the player's shoulder.

The rod 102 can be pre-shaped to suit most players, though its shape can preferably be adjusted by hand to better fit the shape of the body of the particular person. The counterweight 104 can be adjusted to provide desirable balancing force to counterbalance the weight of the instrument 108. This adjustment of the balancing force may be performed by moving counterweight 104 along the rod, by adding more counterweights, by using counterweight of variable mass, such as canister filled with liquid or sand.

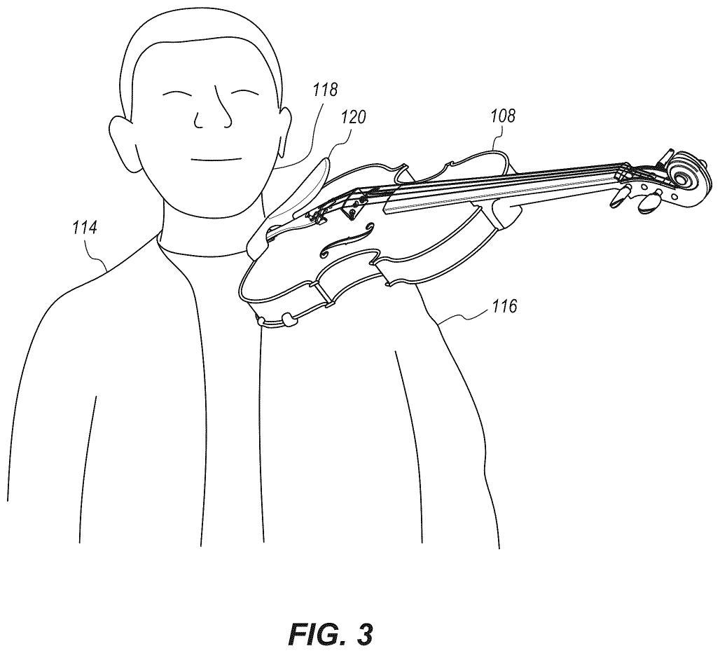

FIG. 3 illustrates a front view of a person 114 using the apparatus 100 in accordance with an embodiment of the present invention. As shown in FIG. 3, the support apparatus 100 and instrument 108 can be configured and balanced in such a way that the instrument is positioned on the person's shoulder 116 in a suitable playing position without the person's chin 118 touching a chin rest 120 of the instrument 108 and without the person supporting the instrument 108 using their hands.

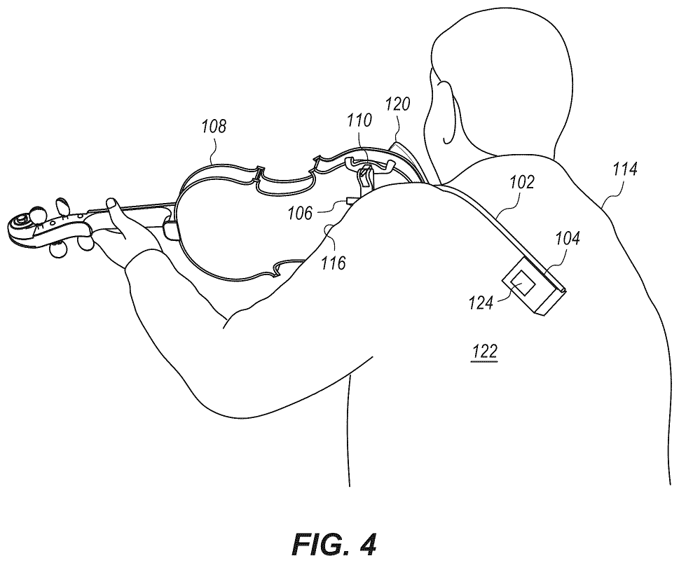

FIG. 4 illustrates a rear view of a person 114 using the support apparatus 100 in accordance with an embodiment of the present invention. As shown in FIG. 4, the instrument 108 is in suitable position thereby allowing the person 114 to play the instrument 108. Here, the rod 102 freely rests on the musician's shoulder 116 and allows some movement of the instrument relative to the musician's body 114 that is not uncommon when playing The balancing support apparatus 100 of FIG. 4 allows using of a chin rest 120 or pad in a usual manner, though using the chin rest 120 is not required to hold the instrument 108 in playing position.

The rod 102 may be padded in the area where the rod 102 contacts the player's shoulder 116. For additional comfort, the counterweight 104 may also have a pad positioned between the counterweight 104 and player's back 122 (FIG. 4). For electric instruments, the counterweight 104 may be combined with a wireless transmitter 124 (FIG. 4). The rod 102 may be hollow so as to allow for placement of wiring for electric instruments inside of it.

The total weight of the assembly 100 is typically about 1 Kg (2 pounds), which is sufficiently lightweight that it can be carried on a musician's shoulder comfortably while also maintaining stability in its position. This also applies to electric violins which are usually heavier than traditional, non-electric ones.

The rod 102 may have various attachments, such as microphone, lights, electronic controls and displays. The rod 102 can be made of a copper tube or other bendable material, such as aluminum. Alternatively, or additionally, the rod 102 can be equipped with one or more pivotable joints, such as pivot joints or ball joints, so that bending of the rod 102 rotates the pivotable joints. The counterweight 104 can be of some dense material, such as bronze, copper, iron, stone, etc. or such granulated material such as sand or liquid in a container. Such a container may be flexible for improved comfort.

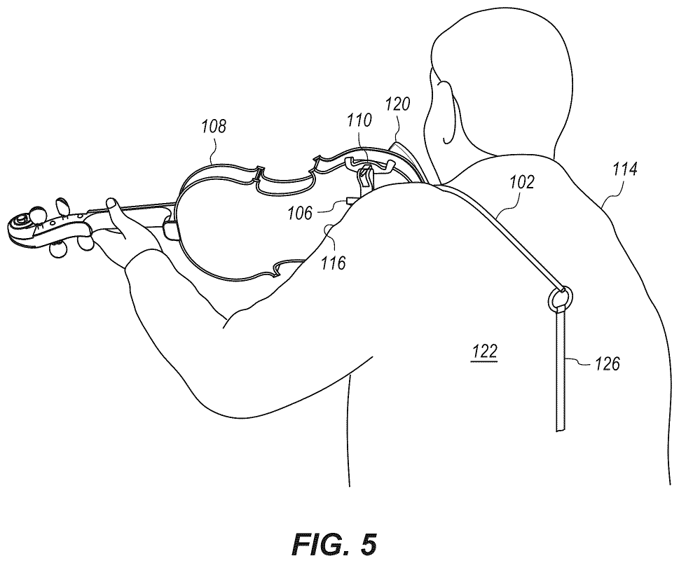

FIG. 5 illustrates a rear view of a person 114 using an apparatus for support of violin or viola in accordance with an alternative embodiment of the present invention. In this embodiment, the counterweight 104 of FIGS. 1-4 is replaced with an elastic element 126. The elastic element 126 can comprise one or more springs or elastic bands. The downforce provided by the counterweight 104 is in this embodiment instead created by the elastic element 126. In this case, the elastic element can be on one end attached to the rod 102 and on another end to the player 114, such as to a belt on the player's waist.

The downforce applied to the rod 102 by the elastic element 126 is preferably adjustable. This can be accomplished, for example, by adjusting tension on the elastic element by adjusting its length or location of attachment to the rod 102 at the one end and/or the location of attachment to the player's body 114 at the other end. As before, the rod 102 freely rests on musician's shoulder 116 and allows some movement of the instrument relative to the musician's body 114 that is not uncommon when playing. The balancing assembly of FIGS. 4 and 5 also allows using of a chin rest 120 or pad in a usual manner, though it's not required to hold the instrument 108 in playing position.

The foregoing detailed description of the present invention is provided for the purposes of illustration and is not intended to be exhaustive or to limit the invention to the embodiments disclosed. Accordingly, the scope of the present invention is defined by the appended claims.

What is claimed is:

1. An apparatus for supporting a violin or viola instrument in a playing position comprising:
a rod having a changeable shape and configured for resting on a player's shoulder, the rod being sufficiently malleable that its shape is changeable by hand for adjustment and the rod being sufficiently rigid that it maintains it shape during playing of the instrument;
an attachment mechanism configured to attach the rod to a violin or viola; and
a counterweight attached to the rod at a distance from the attachment mechanism, wherein adjustment of the rod and adjustment of counterweight are capable of achieving a center of gravity of the instrument and apparatus being in or around an area where apparatus rests on the player's shoulder.

2. The apparatus according to claim 1, wherein the distance is adjustable by changing a position of the counterweight along the rod.

3. The apparatus according to claim 1, wherein the counterweight is adjustable by adding or removing mass to or from the counterweight.

4. The apparatus according to claim 1, wherein the rod is shaped to pass over the player's shoulder adjacent to the instrument and the counterweight positioned adjacent to the player's back during playing of the instrument.

5. The apparatus according to claim 1, wherein the shape of the rod is changeable by hand to fit the shape of the player's shoulder and to provide adjustment to positioning of the instrument for playing of the instrument.

6. The apparatus according to claim 1, wherein the rod is formed of a malleable material.

7. The apparatus according to claim 1, wherein the rod comprises one or more pivotable joints.

8. The apparatus according to claim 1, wherein the attachment mechanism comprises a shoulder rest, wherein the rod is attached to the shoulder rest.

9. The apparatus according to claim 8, wherein the attachment mechanism further comprises clamps configured to attach to the instrument.

10. The apparatus according to claim 1, further comprising a pad attached to the rod and configured to be positioned between the rod and player's shoulder during playing of the instrument.

11. The apparatus according to claim 1, further comprising a pad attached to the counterweight and configured to be positioned between the counterweight and player's back during playing of the instrument.

12. An apparatus for supporting a violin or viola instrument in a playing position comprising:
a rod having a changeable shape and configured for resting on a player's shoulder, the rod being sufficiently malleable that its shape is changeable by hand for adjustment and the rod being sufficiently rigid that it maintains it shape during playing of the instrument;
an attachment mechanism configured to attach the rod to a violin or viola; and
an elastic element attached to the rod at a distance from the attachment mechanism and configured to be attached to the player, wherein adjustment of the rod and adjustment of elastic element are capable of achieving a center of gravity of the instrument and apparatus being in or around an area where apparatus rests on the player's shoulder.

13. The apparatus according to claim 12, wherein the elastic element is adjustable by adjusting a tension of the elastic element.

14. A method of supporting a violin or viola instrument in a playing position comprising:
configuring a rod having a changeable shape such that the rod rests on a player's shoulder, wherein the rod is sufficiently malleable that its shape is changeable by hand for adjustment and the rod is sufficiently rigid that it maintains it shape during playing of the instrument;
attaching a first end of the rod to the instrument;
attaching a counterweight to the rod at a distance from the first end;
adjusting one or more of the distance, mass of the counterweight, and the changeable shape of the rod such that a center of gravity of the instrument and attached rod and counterweight is in or around an area where the rod or instrument rests on the player's shoulder.

15. The method according to claim 14, wherein adjusting the distance comprises changing a position of the counterweight along the rod.

16. The method according to claim 14, wherein the rod is shaped to pass over the player's shoulder adjacent to the instrument and the counterweight positioned adjacent to the player's back during playing of the instrument.

17. The method according to claim 14, wherein the shape of the rod is changeable by hand to fit the shape of the player's shoulder and to provide adjustment to positioning of the instrument for playing of the instrument.

18. The method according to claim 14, wherein the rod is formed of a malleable material.

19. The method according to claim 14, wherein the rod comprises one or more pivotable joints.

20. The method according to claim 14, further comprising providing a shoulder rest, wherein the rod is attached to the shoulder rest.

21. The method according to claim 14, further comprising providing clamps configured to attach to the instrument.
